(19) United States
(12) Patent Application Publication
(10) Pub. No.: US 2018/0162541 A1
(43) Pub. Date: Jun. 14, 2018

(54) VARIABLE INCIDENT NACELLE APPARATUS AND METHODS

(71) Applicant: The Boeing Company, Chicago, IL (US)

(72) Inventors: Christopher T. Jasklowski, Redmond, WA (US); Omid B. Nakhjavani, Kirkland, WA (US)

(21) Appl. No.: 15/379,101

(22) Filed: Dec. 14, 2016

(51) Int. Cl. B64D 27/26; B64D 29/02; B64D 29/06; B64C 9/16

(52) U.S. Cl. CPC B64D 27/26; B64D 29/02; B64D 2027/262; B64C 9/16; B64D 29/06

(57) ABSTRACT

Variable incident nacelle apparatus and methods are disclosed herein. An apparatus for varying an incident angle of a nacelle of an aircraft engine relative to an aircraft wing comprises a pylon frame member to be rigidly coupled to the aircraft engine. The pylon frame member is to be pivotable about a first axis of rotation. The apparatus further comprises a diagonal brace including a first end defining an aperture to receive a portion of a drive member. The portion of the drive member is to be rotatable relative to the aperture about a second axis of rotation. The drive member includes a pin positioned eccentrically relative to the second axis of rotation. The pin is to be coupled to the pylon frame member to pivot the pylon frame member in response to rotation of the portion of the drive member.

### FIELD OF THE DISCLOSURE

This disclosure relates generally to aircraft engine nacelles and, more specifically, to variable incident nacelle apparatus and methods.

### BACKGROUND

Nacelles of commercial aircraft engines are conventionally coupled to the wings of the commercial aircraft in a rigid manner via fixed-frame (e.g., non-movable) pylons. As the size of commercial aircraft has increased over time, so too has the size (e.g., the diameter) of the nacelles and/or engines of such aircraft. An increase in the diameter of the nacelle of the aircraft engine may create ground clearance concerns with respect to the nacelle when the aircraft is taking off and/or landing, and/or when the landing gear of the aircraft is deployed and is in contact with an underlying ground surface.

Known techniques for addressing the aforementioned ground clearance concerns include increasing the length of the landing gear of the aircraft to provide a corresponding increase in the height of the wings of the aircraft when the landing gear is deployed (e.g., when the landing gear is in contact with an underlying ground surface). Increasing the length of the landing gear, however, typically increases the weight of the aircraft (e.g., relative to a similarly-sized aircraft having landing gear of a relatively shorter length), and may also reduce the available fuel storage space of the aircraft (e.g., relative to a similarly-sized aircraft having landing gear of a relatively shorter length and/or a relatively smaller footprint). Increasing the weight of the aircraft and/or reducing the available fuel storage space of the aircraft adversely impacts operational costs associated with commercial aircraft.

### SUMMARY

Variable incident nacelle apparatus and methods are disclosed herein. In some examples, an apparatus for varying an incident angle of a nacelle of an aircraft engine relative to an aircraft wing is disclosed. In some disclosed examples, the apparatus comprises a pylon frame member to be rigidly coupled to the aircraft engine. In some disclosed examples, the pylon frame member is to be pivotable about a first axis of rotation. In some disclosed examples, the apparatus further comprises a diagonal brace including a first end defining an aperture to receive a portion of a drive member. In some disclosed examples, the portion of the drive member is to be rotatable relative to the aperture about a second axis of rotation. In some disclosed examples, the drive member includes a pin positioned eccentrically relative to the second axis of rotation. In some disclosed examples, the pin is to be coupled to the pylon frame member to pivot the pylon frame member in response to rotation of the portion of the drive member.

In some examples, a method for varying an incident angle of a nacelle of an aircraft engine movably coupled to an aircraft wing is disclosed. In some disclosed examples, the method comprises rotating a portion of a drive member about a first axis of rotation. In some disclosed examples, the portion of the drive member is received in an aperture defined by a first end of a diagonal brace. In some disclosed examples, the drive member includes a pin positioned eccentrically relative to the first axis of rotation. In some disclosed examples, the pin is coupled to a pylon frame member to pivot the pylon frame member in response to the rotation of the portion of the drive member. In some disclosed examples, the pylon frame member is rigidly coupled to the aircraft engine and pivotable about a second axis of rotation.

In some examples, a tangible machine readable storage medium comprising instructions is disclosed. In some disclosed examples, the instructions, when executed, cause a controller to determine a desired position of a nacelle of an aircraft engine movably coupled to an aircraft wing. In some disclosed examples, the instructions, when executed, further cause the controller to generate a control signal to move the nacelle to the desired position. In some disclosed examples, the control signal is to rotate a portion of a drive member about a first axis of rotation. In some disclosed examples, the portion of the drive member is received in an aperture defined by a first end of a diagonal brace. In some disclosed examples, the drive member includes a pin positioned eccentrically relative to the first axis of rotation. In some disclosed examples, the pin is coupled to a pylon frame member to pivot the pylon frame member in response to the rotation of the portion of the drive member. In some disclosed examples, the pylon frame member is rigidly coupled to the aircraft engine and pivotable about a second axis of rotation.

### BRIEF DESCRIPTION OF THE DRAWINGS

FIG. 1 illustrates an example aircraft in which an example variable incident nacelle apparatus may be implemented in accordance with the teachings of this disclosure.

FIG. 2 is a side view illustrating an example variable incident nacelle apparatus in a first position.

FIG. 3 is a side view illustrating the example variable incident nacelle apparatus of FIG. 2 in a second position.

FIG. 4 is a side view illustrating the example pylon frame of FIGS. 2 and 3 in the first position of FIG. 2.

FIG. 5 is a side view illustrating the example pylon frame of FIGS. 2-4 in the second position of FIG. 3.

FIG. 6 is a side view illustrating the example drive shaft and the example drive pin of FIGS. 4 and 5 coupled to the example diagonal brace of FIGS. 2-5.

FIG. 7 is a perspective view illustrating the example drive shaft and the example drive pin of FIGS. 4-6 coupled to the example diagonal brace of FIGS. 2-6.

FIG. 8 is a perspective view of an example heat blanket operatively coupled to the example drive shaft of FIG. 7.

FIG. 9 is a block diagram of an example nacelle positioning control apparatus for controlling a position of an example drive member and/or for controlling an incident angle of an example nacelle positionable via the example variable incident nacelle apparatus of FIGS. 2-8.

FIG. 10 is a flowchart representative of a first example method that may be executed at the example nacelle positioning control apparatus of FIG. 9 to control an incident angle of a nacelle positionable via the example variable incident nacelle apparatus of FIGS. 2-8.

FIG. 11 is a flowchart representative of a second example method that may be executed at the example nacelle positioning control apparatus of FIG. 9 to control an incident angle of a nacelle positionable via the example variable incident nacelle apparatus of FIGS. 2-8.

FIG. 12 is an example processor platform capable of executing instructions to implement the methods of FIGS. 10 and 11 and the example nacelle positioning control apparatus of FIG. 9.

Certain examples are shown in the above-identified figures and described in detail below. In describing these examples, like or identical reference numbers are used to identify the same or similar elements. The figures are not necessarily to scale and certain features and certain views of the figures may be shown exaggerated in scale or in schematic for clarity and/or conciseness.

### DETAILED DESCRIPTION

Conventional nacelle attachment apparatus (e.g., fixed-frame pylons) rigidly couple a nacelle and/or engine of an aircraft to the wing of the aircraft. In such configurations, the position and/or orientation of the nacelle is fixed relative to the position and/or orientation of the wing. As a result of the rigid and/or fixed nature of such conventional apparatus, an increase in the diameter of the nacelle of the aircraft engine typically requires a corresponding increase in the length of the landing gear of the aircraft to avoid ground clearance concerns relating to the nacelle (e.g., the possibility of the nacelle contacting an underlying ground surface while aircraft is taking of and/or landing, and/or while the landing gear is deployed and is in contact with the underlying ground surface). Known techniques for addressing the aforementioned ground clearance concerns (e.g., increasing the length of the landing gear of the aircraft) typically increase the weight of the aircraft and/or reduce the available fuel storage space of the aircraft. Increasing the weight of the aircraft and/or reducing the available fuel storage space of the aircraft adversely impacts operational costs associated with commercial aircraft.

Unlike conventional nacelle attachment apparatus that rigidly couple the nacelle and/or engine of the aircraft to the wing of the aircraft, the variable incident nacelle apparatus and methods disclosed herein enable the nacelle and/or the engine to be positioned and/or moved relative to the wing at incident angles of varying degrees. Implementation of the disclosed variable incident nacelle apparatus and methods in an aircraft (e.g., a derivative commercial aircraft) advantageously enables a nacelle and/or an engine of increased diameter to be fitted to the aircraft without the need for increasing the length of the landing gear of the aircraft. As a result, increases to the weight of the aircraft and/or reductions to the available fuel storage space of the aircraft associated with increasing the length of the landing gear are reduced and/or avoided. For example, an increase in weight and/or reduction in available fuel storage space associated with implementing the disclosed variable incident nacelle apparatus may trade positively against the increase in weight and/or the reduction in available fuel storage space associated with increasing the length of the landing gear. Thus, implementation of the disclosed variable incident nacelle apparatus is advantageous with respect to the operating costs associated with commercial aircraft.

Implementation of the disclosed variable incident nacelle apparatus and methods in an aircraft also advantageously improves a specific fuel consumption of the aircraft and/or provides a drag benefit associated with a cruising operation of the aircraft. Improvements in specific fuel consumption and/or drag benefits are achieved via the disclosed variable incident nacelle apparatus by aligning and/or positioning the nacelle at an incident angle corresponding to a velocity vector associated with the aircraft during the cruising operation.

Implementation of the disclosed variable incident nacelle apparatus and methods in an aircraft also advantageously reduces a load and/or force applied to an extended wing flap of the aircraft resulting from an exhaust plume generated by the engine of the aircraft. Reductions in the load and/or forces applied to the extended wing flap of the aircraft resulting from the exhaust plume of the engine are achieved via the disclosed variable incident nacelle apparatus by aligning and/or positioning the nacelle and/or the engine at an incident angle that causes the exhaust plume of the engine to be directed away from the extended wing flap. As a result of the reduction in loads and/or forces applied to the extended wing flap of the aircraft, the wing flap may be designed to withstand lower loads and/or forces, which may in turn result in a wing flap design of a relatively lower weight. In addition to reducing the load and/or forces applied to the extended wing flap, aligning and/or positioning the nacelle and/or the engine at an incident angle that causes the exhaust plume of the engine to be directed away from the extended wing flap also advantageously reduces noise that otherwise results from the engine plume impacting the extended wing flap.

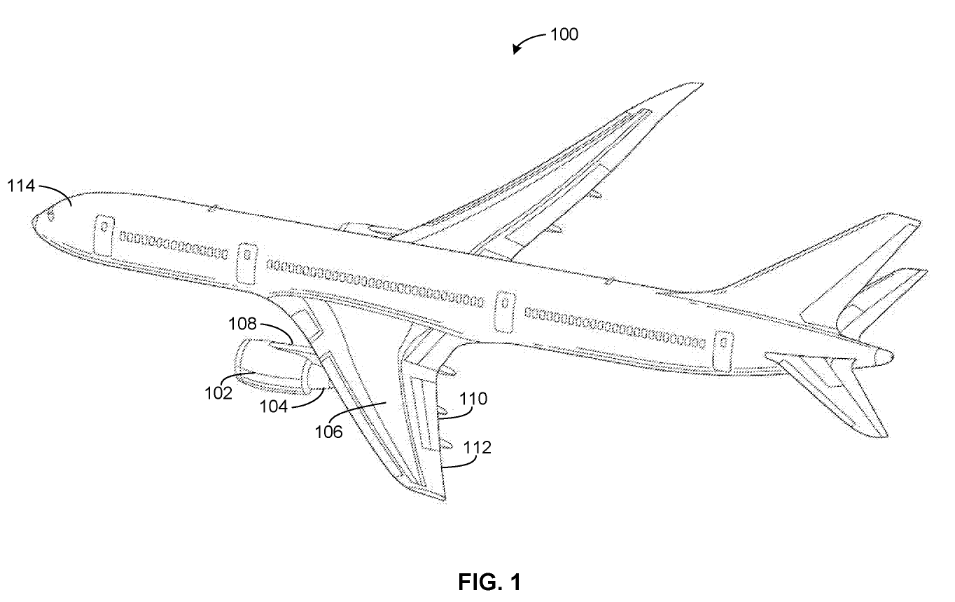

FIG. 1 illustrates an example aircraft 100 in which example variable incident nacelle apparatus and example nacelle positioning control apparatus may be implemented in accordance with the teachings of this disclosure. The aircraft 100 includes an example nacelle 102 of an example engine 104. The nacelle 102 and/or the engine 104 is/are coupled to an example wing 106 of the aircraft 100 via an example pylon 108. The wing 106 includes one or more flap(s) 110 mounted to an example trailing edge 112 of the wing 106. In the illustrated example of FIG. 1, the flap 110 is shown in a retracted position that is approximately flush with one or more surfaces of the airfoil of the wing 106. The flap 110 is movable from the illustrated retracted position to an extended position (not shown) in which the flap 110 is extended rearward and/or downward from the trailing edge 112 of the wing 106. When positioned in the extended position, the flap 110 may be subjected to an exhaust plume of the engine 104. Movement of the flap 110 of the wing 106 between the retracted position and the extended position may be controlled by a controller that receives inputs via an input device (e.g., a button, a switch, a dial, etc.) positioned in an example cockpit area 114 of the aircraft 100.

Example variable incident nacelle apparatus described herein provide for a variable incident nacelle having an incident angle that is controllable via example nacelle positioning control apparatus described herein. With reference to FIG. 1, implementation of example variable incident nacelle apparatus and example nacelle positioning control apparatus described herein enable the nacelle 102 and/or the engine 104 to be movable and/or positionable relative to the wing 106 of the aircraft 100. Example variable incident nacelle apparatus and example nacelle positioning control apparatus described herein may be implemented in commercial aircraft (e.g., the aircraft 100 of FIG. 1, commercial drones, etc.) as well as other types of aircraft (e.g., military aircraft, military drones, etc.).

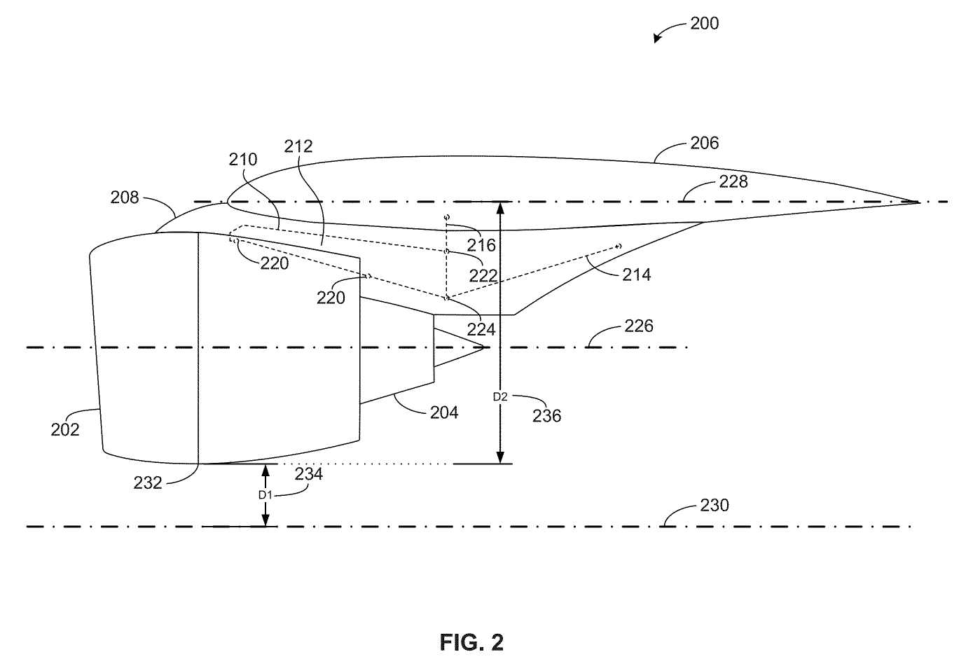

FIG. 2 is a side view illustrating an example variable incident nacelle apparatus 200 in a first example position. The variable incident nacelle apparatus 200 movably couples an example nacelle 202 of an example engine 204 to an example wing 206 of an aircraft. The variable incident nacelle apparatus 200 includes an example pylon frame 210, a portion of which is housed within an example pylon 208 of the aircraft. The pylon frame 210 includes an example pivotable frame member 212, an example diagonal brace 214, an example side brace 216, and an example drive member (not shown). Any of the pivotable frame member 212, the diagonal brace 214, the side brace 216, the drive member and/or, more generally, the pylon frame 210 may be implemented as one or more strut(s), bar(s), rod(s), shaft(s), pin(s), plate(s), linkage(s), etc.

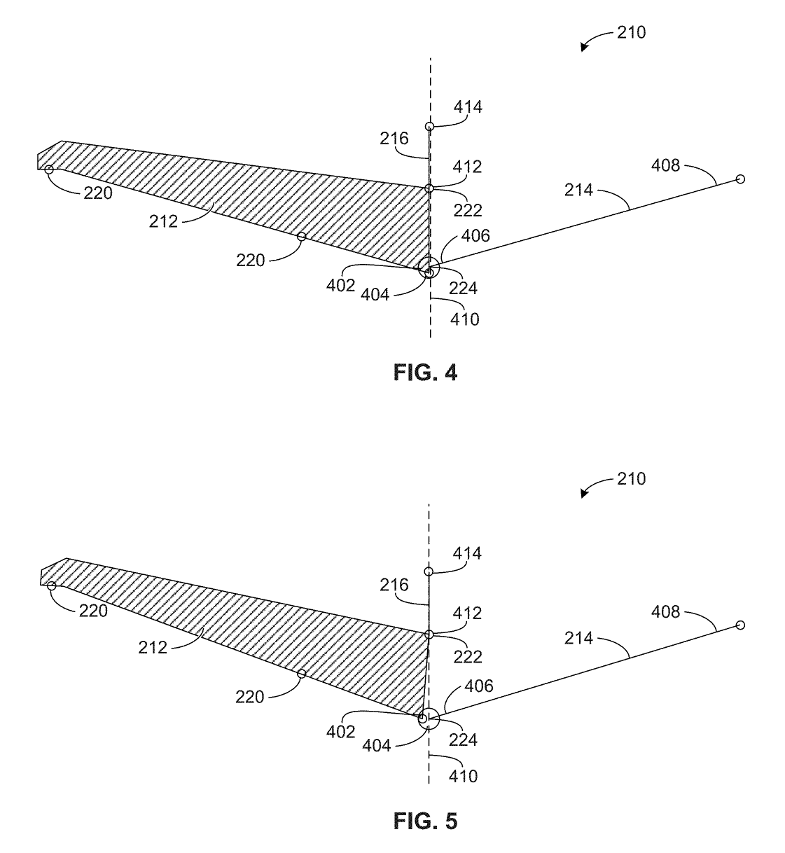

In the illustrated example of FIG. 2, the pivotable frame member 212 is rigidly coupled (e.g., directly or indirectly) to the nacelle 202 and/or the engine 204 at one or more example mounting point(s) 220. Thus, movement of the pivotable frame member 212 results in corresponding movement of the nacelle 202 and/or the engine 204. In the illustrated example of FIG. 2, the pivotable frame member 212 pivots and/or rotates about an example pivot point 222. As described in greater detail below in connection with FIGS. 4-8, the drive member of the pylon frame 210 is rotatably coupled (e.g., directly or indirectly) to the diagonal brace 214 of the pylon frame 210 at an example drive point 224, and the drive member is rigidly coupled (e.g., directly or indirectly) to the pivotable frame member 212 at the drive point 224. As a result of the rotatable coupling between the drive member and the diagonal brace 214, and as a result of the rigid coupling between the drive member and the pivotable frame member 212, movement (e.g., rotation) of the drive member results in corresponding movement (e.g., rotation) of the pivotable frame member 212.

In the illustrated example of FIG. 2, the diagonal brace 214 and/or the side brace 216 couple (e.g., directly or indirectly) the pivotable frame member 212 to the wing 206. One or more of the diagonal brace 214 and/or the side brace 216 may stabilize the pivotable frame member 212 in response to forces conveyed and/or transferred to the pivotable frame member 212 from the nacelle 202 and/or the engine 204.

Example structures, functions and/or operations of the pivotable frame member 212, the diagonal brace 214, the side brace 216, and the drive member of the pylon frame 210 are described in greater detail herein in connection with FIGS. 4-8. Although the pivotable frame member 212, the diagonal brace 214, the side brace 216 and the drive member of the pylon frame 210 are illustrated in FIG. 2 as having specific shapes, sizes, orientations and/or configurations, the pivotable frame member 212, the diagonal brace 214, the side brace 216 and the drive member of the pylon frame 210 may be of any shapes, sizes, orientations and/or configurations that enable the pylon frame 210 to movably couple the nacelle 202 of the engine 204 to the wing 206. In some examples, the pylon frame 210 may include one or more structures in addition to and/or as an alternative to the pivotable frame member 212, the diagonal brace 214, the side brace 216 and/or the drive member. For example, the pylon frame may include one or more upper links that assist in coupling the pivotable frame member and/or, more generally, the pylon frame 210 to the wing 206.

When the variable incident nacelle apparatus 200 is in the first position of FIG. 2, an example longitudinal axis 226 of the nacelle 202 and/or the engine 204 is substantially parallel to an example chord 228 of the wing 206. As illustrated in FIG. 2, the longitudinal axis 226 of the nacelle 202 and/or the engine 204 is also substantially parallel to an example underlying ground surface 230. The chord 228 of the wing 206 of the aircraft may positioned at a fixed distance from the underlying ground surface 230 as defined by the landing gear (not shown) of the aircraft when the aircraft is grounded. In the illustrated example of FIG. 2, an incident angle of the nacelle 202 may be identified as the angle between the longitudinal axis 226 of the nacelle 202 and the chord 228 of the wing 206. Thus, with the variable incident nacelle apparatus 200 positioned in the first position of FIG. 2, the nacelle 202 has an incident angle of approximately zero degrees.

When the variable incident nacelle apparatus 200 is in the first position of FIG. 2, a first example lowest extent 232 of the nacelle 202 is separated from the underlying ground surface 230 by an example first distance (D1) 234, and separated from the chord 228 of the wing 206 by an example second distance (D2) 236. In some examples, an exhaust plume (not shown) generated by the engine 204 when the variable incident nacelle apparatus 200 is in the first position of FIG. 2 (e.g., when the nacelle 202 has an incident angle of approximately zero degrees) may impact an extended flap (not shown) of the wing 206.

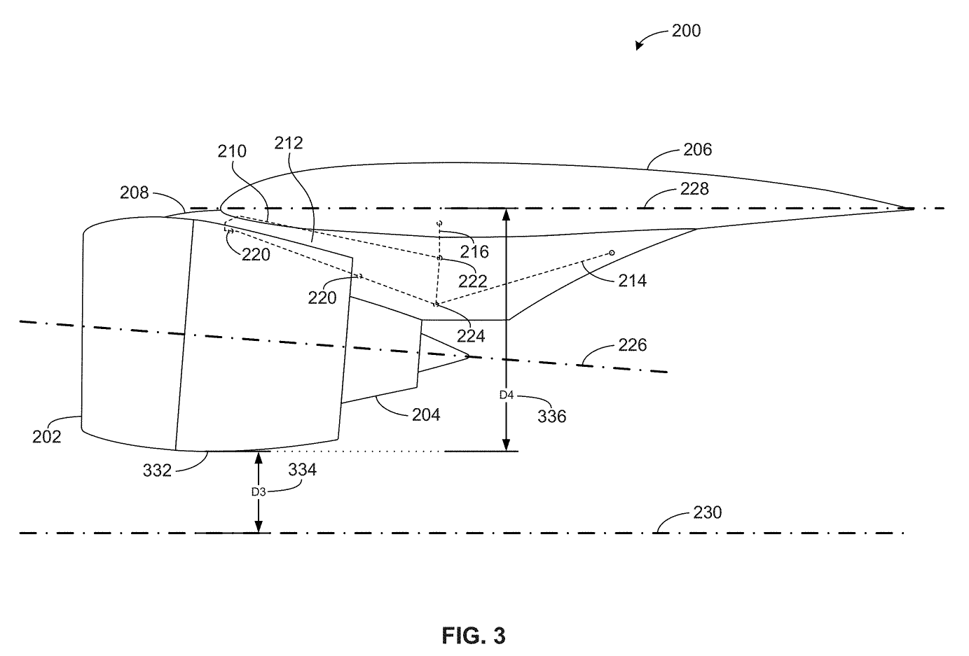

FIG. 3 is a side view illustrating the example variable incident nacelle apparatus 200 of FIG. 2 in a second example position. When the variable incident nacelle apparatus 200 is in the second position of FIG. 3, the longitudinal axis 226 of the nacelle 202 and/or the engine 204 is positioned at an angle of approximately five degrees relative to the chord 228 of the wing 206 and/or relative to the underlying ground surface 230. Thus, with the variable incident nacelle apparatus 200 positioned in the second position of FIG. 3, the nacelle 202 has an incident angle of approximately five degrees. The variable incident nacelle apparatus 200 may have a range of movement that exceeds that which is shown and described in connection with FIGS. 2 and 3. For example, the variable incident nacelle apparatus 200 may enable the nacelle 202 and/or the engine 204 to be positioned and/or moved relative to the wing 206 at incident angles varying between zero and thirty degrees for the example pylon frame 210 illustrated and described in connection with FIGS. 4 and 5. The range of incident angles may be increased to one hundred degrees for a pylon frame of a size, shape, orientation and/or configuration differing from that of the example pylon frame 210 of FIGS. 4 and 5.

When the variable incident nacelle apparatus 200 is in the second position of FIG. 3, a second example lowest extent 332 of the nacelle 202 is separated from the underlying ground surface 230 by an example third distance (D3) 334, and separated from the chord 228 of the wing 206 by an example fourth distance (D4) 336. The third distance (D3) 334 of FIG. 3 is greater than the first distance (D1) 234 of FIG. 2. Thus, movement of the nacelle 202 from the first position of FIG. 2 to the second position of FIG. 3, via the variable incident nacelle apparatus 200, increases the extent of ground clearance of the nacelle 202 relative to the underlying ground surface 230 of FIGS. 2 and 3. Conversely, the fourth distance (D4) 336 of FIG. 3 is less than the second distance (D2) 236 of FIG. 2. Thus, movement of the nacelle 202 from the first position of FIG. 2 to the second position of FIG. 3, via the variable incident nacelle apparatus 200, reduces the distance between the lowest extent of the nacelle 202 and the chord 228 of the wing 206 of FIGS. 2 and 3. In some examples, an exhaust plume (not shown) generated by the engine 204 when the variable incident nacelle apparatus 200 is in the second position of FIG. 3 (e.g., when the nacelle 202 has an incident angle of approximately five degrees) may impact an extended flap (not shown) of the wing 206 to a reduced and/or lesser extent than would be the case when the variable incident nacelle apparatus 200 is in the first position of FIG. 2 (e.g., when the nacelle 202 has an incident angle of approximately zero degrees).

In some examples, the increased ground clearance of the nacelle 202 stemming from the difference between the third distance (D3) 334 of FIG. 3 and the first distance (D1) 234 of FIG. 2 may be several inches (e.g., ten inches for the example pylon frame 210 illustrated and described in connection with FIGS. 4 and 5). In other examples, the increased ground clearance of the nacelle 202 stemming from the difference between the third distance (D3) 334 of FIG. 3 and the first distance (D1) 234 of FIG. 2 may be several feet (e.g., six feet or more) for a pylon frame of a size, shape, orientation and/or configuration differing from that of the example pylon frame 210 of FIGS. 4 and 5. Similarly, in some examples, the reduced distance between the lowest extent of the nacelle 202 and the chord of the wing 206 stemming from the difference between the fourth distance (D4) 336 of FIG. 3 and the second distance (D2) 236 of FIG. 2 may be several inches (e.g., ten inches for the example pylon frame 210 illustrated and described in connection with FIGS. 4 and 5). In other examples, the reduced distance between the lowest extent of the nacelle 202 and the chord of the wing 206 stemming from the difference between the fourth distance (D4) 336 of FIG. 3 and the second distance (D2) 236 of FIG. 2 may be several feet (e.g., six feet or more) for a pylon frame of a size, shape, orientation and/or configuration differing from that of the example pylon frame 210 of FIGS. 4 and 5.

FIG. 4 is a side view illustrating the example pylon frame 210 of FIGS. 2 and 3 positioned in the first position of FIG. 2. As generally described above in connection with FIGS. 2 and 3, the pylon frame 210 includes the pivotable frame member 212, the diagonal brace 214, the side brace 216 and a drive member. In the illustrated example of FIG. 4, the drive member is implemented as an example drive shaft 402 having an example eccentric drive pin 404. In some examples, the drive pin 404 may be integrally formed with the drive shaft 402. In other examples, the drive pin 404 may be rigidly coupled (e.g., directly or indirectly) to the drive shaft 402.

In the illustrated example of FIG. 4, the drive pin 404 is rigidly coupled (e.g., directly or indirectly) to the pivotable frame member 212 of the pylon frame 210 at the drive point 224, and the drive shaft 402 is rotatably coupled (e.g., directly or indirectly) to the diagonal brace 214 of the pylon frame 210 at an example first end 406 of the diagonal brace 214 proximate the drive point 224. The first end 406 of the diagonal brace 214 is rigidly coupled (e.g., directly or indirectly) to the pylon 208. An example second end 408 of the diagonal brace 214 opposite the first end 406 of the diagonal brace 214 provides an attachment point for rigidly coupling (e.g., directly or indirectly) the diagonal brace 214 to the pylon 208 and/or to the wing 206. Thus, the diagonal brace 214 is rigidly positioned (e.g., non-movable) relative to the wing 206.

In the illustrated example of FIG. 4, a longitudinal axis (not shown) of the eccentric drive pin 404 of the drive shaft 402 intersects an example vertical reference line 410. The drive shaft 402 and/or the drive pin 404 rotate about an axis (not shown) that is substantially transverse to the vertical reference line 410 and substantially parallel to an axis of rotation (not shown) defined by the pivot point 222 about which the pivotable frame member 212 rotates and/or pivots. When the longitudinal axis of the drive pin 404 intersects the vertical reference line 410 as shown in FIG. 4, the variable incident nacelle apparatus 200 is in a position corresponding to the first position of FIG. 2 described above (e.g., the nacelle 202 having an incident angle of approximately zero degrees).

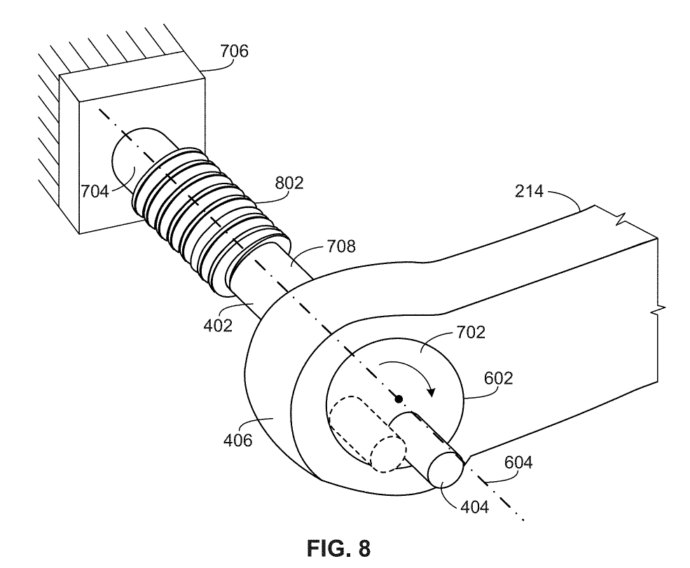

As a result of the rotatable coupling between the drive shaft 402 and the diagonal brace 214, and as a result of the rigid coupling between the eccentric drive pin 404 and the pivotable frame member 212, movement (e.g., rotation) of the drive shaft 402 and/or the drive pin 404 results in corresponding movement (e.g., rotation) of the pivotable frame member 212. The drive shaft 402 of FIG. 4 may be rotated by any number and/or type(s) of actuator(s) including, for example, one or more hydraulic actuator(s), one or more pneumatic actuator(s), one or more electrical actuator(s), and/or one or more mechanical actuator(s). An example actuator for rotating the drive shaft 402 of FIG. 4 is described in greater detail below in connection with FIG. 8.

In the illustrated example of FIG. 4, the pivotable frame member 212 pivots and/or rotates about an axis of rotation defined by the pivot point 222. The pivotable frame member 212 is rotatably coupled (e.g., directly or indirectly) to the side brace 216 of the pylon frame 210 at an example first end 412 of the side brace 216. The first end 412 of the side brace 216 is rigidly coupled (e.g., directly or indirectly) to the pylon 208. An example second end 414 of the side brace 216 opposite the first end 412 of the side brace 216 provides an attachment point for rigidly coupling (e.g., directly or indirectly) the side brace 216 to the wing 206. Thus, the side brace 316 is rigidly positioned (e.g., non-movable) relative to the wing 206. In the illustrated example of FIG. 4, a longitudinal axis (not shown) of the side brace 216 is substantially aligned with the vertical reference line 410.

FIG. 5 is a side view illustrating the example pylon frame 210 of FIGS. 2-4 positioned in the second position of FIG. 3. In the illustrated example of FIG. 5, a longitudinal axis (not shown) of the eccentric drive pin 404 of the drive shaft 402 does not intersect the vertical reference line 410. In this regard, the eccentric drive pin 404 as shown in FIG. 5 has been rotated approximately ninety degrees (e.g., ninety degrees clockwise) relative to the location of the eccentric drive pin 404 as shown in FIG. 4. As described above, the drive shaft 402 and/or the drive pin 404 rotate about an axis of rotation (not shown) that is substantially transverse to the vertical reference line 410 and substantially parallel to an axis of rotation (not shown) defined by the pivot point 222 about which the pivotable frame member 212 rotates and/or pivots. When the longitudinal axis of the drive pin 404 does not intersect (e.g., is offset from) the vertical reference line 410, as is illustrated in FIG. 5, the variable incident nacelle apparatus 200 is in a position corresponding to the second position of FIG. 3 described above (e.g., the nacelle 202 having an incident angle of approximately five degrees). Accordingly, as illustrated in FIG. 5 relative to FIG. 4, the movement (e.g., rotation) of the drive shaft 402 and/or the drive pin 404 results in corresponding movement (e.g., rotation) of the pivotable frame member 212. For example, as illustrated in FIGS. 4 and 5, an approximately ninety degree rotation of the drive shaft 402 and/or the drive pin 404 may result in a corresponding change of approximately five degrees for the incident angle of the nacelle 202 and/or the engine 204 rigidly coupled to the pivotable frame member 212.

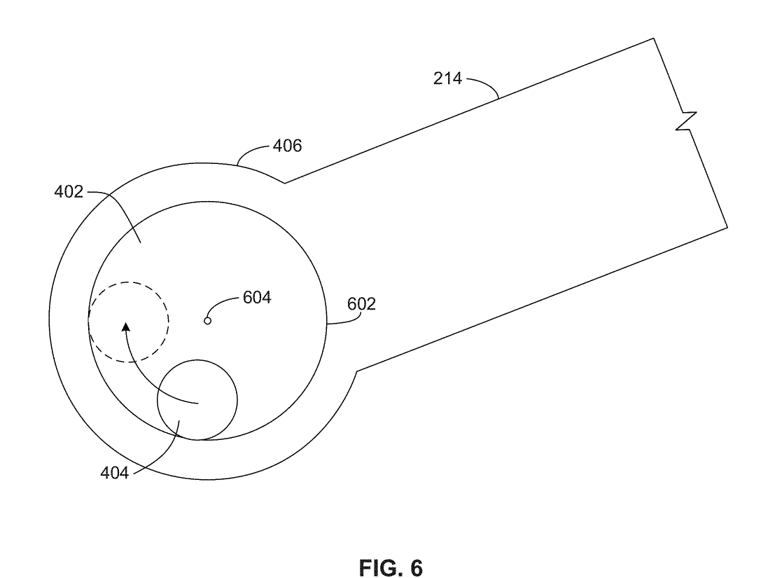

FIG. 6 is a side view illustrating the example drive shaft 402 and the example drive pin 404 of FIGS. 4 and 5 coupled to the example diagonal brace 214 of FIGS. 2-5. In the illustrated example of FIG. 6, the first end 406 of the diagonal brace 214 defines an example aperture 602 for rotatably coupling the drive shaft 402 to the diagonal brace 214. A portion of the drive shaft 402 (e.g., an end of the drive shaft 402) is positioned in the aperture 602 of the first end 406 of the diagonal brace 214 and rotates relative thereto about an example axis of rotation 604. In the illustrated example of FIG. 6, the eccentric drive pin 404 is shown in a first position corresponding to the position of the eccentric drive pin 404 as shown and described above in connection with FIG. 4. FIG. 6 further illustrates a second position (shown in phantom in FIG. 6) of the eccentric drive pin 404 corresponding to the position of the eccentric drive pin 404 as shown and described above in connection with FIG. 5. Thus, as illustrated in FIG. 6, the eccentric drive pin 404 is rotatable relative to the aperture 602 of the first end 406 of the diagonal brace 214 about the axis of rotation 604 of the drive shaft 402. Rotation of the drive shaft 402 about the axis of rotation 604 accordingly results in a corresponding rotation of the drive pin 404 about the axis of rotation 604.

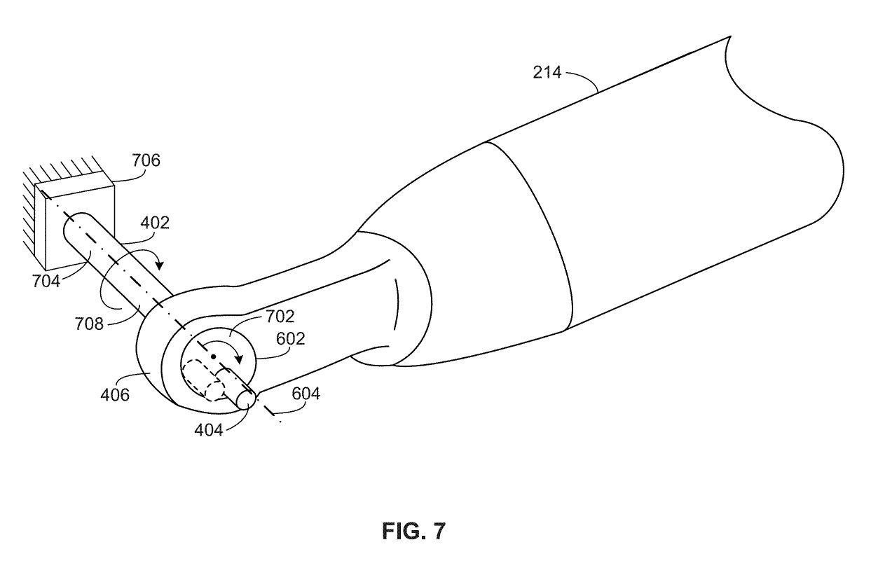

FIG. 7 is a perspective view illustrating the example drive shaft 402 and the example drive pin 404 of FIGS. 4-6 coupled to the example diagonal brace 214 of FIGS. 2-6. In the illustrated example of FIG. 6, the first end 406 of the diagonal brace 214 defines the aperture 602 for rotatably coupling the drive shaft 402 to the diagonal brace 214. The drive shaft 402 includes an example first end 702 positioned in the aperture 602 of the first end 406 of the diagonal brace 214. The first end 702 of the drive shaft 402 rotates relative to the aperture 602 of the first end 406 of the diagonal brace 214 about the axis of rotation 604. In the illustrated example of FIG. 7, the eccentric drive pin 404 is shown in a first position corresponding to the position of the eccentric drive pin 404 as shown and described above in connection with FIG. 4. FIG. 7 further illustrates a second position (shown in phantom in FIG. 7) of the eccentric drive pin 404 corresponding to the position of the eccentric drive pin 404 as shown and described above in connection with FIG. 5. Thus, as illustrated in FIG. 7, the eccentric drive pin 404 is rotatable relative to the aperture 602 of the first end 406 of the diagonal brace 214 about the axis of rotation 604 of the drive shaft 402. Rotation of the first end 702 of the drive shaft 402 about the axis of rotation 604 results in a corresponding rotation of the drive pin 404 about the axis of rotation 604.

In the illustrated example of FIG. 7 the drive shaft 402 includes a second example end 704 opposite the first end 702 of the drive shaft 402. The second end 704 of the drive shaft 402 is rigidly coupled (e.g., fused) to an example mounting structure 706. Accordingly, only the first end 702 of the drive shaft 402 is free to rotate relative to the aperture 602 of the first end 406 of the diagonal brace 214. In the illustrated example of FIG. 7, the drive shaft 402 includes a shape memory alloy 708 such as, for example, a copper-aluminum-nickel shape memory alloy or a nickel-titanium shape memory alloy. The shape memory alloy 708 enables the first end 702 of the drive shaft 402 to deform (e.g., twist and/or rotate about the axis of rotation 604) relative to the rigidly coupled second end 704 of the drive shaft 402.

For example, the shape memory alloy 708 of the drive shaft 402 may be trained and/or configured to cause the first end 702 of the drive shaft 402 to twist and/or rotate about the axis of rotation 604 by a specified amount and/or degree relative to the rigidly coupled second end 704 of the drive shaft 402. In some examples a twisting and/or rotating of the drive shaft 402 via the shape memory alloy 708 from a first position (e.g., a position corresponding to the first position of the drive pin 404 of FIG. 7) to a second position (e.g., a position corresponding to the second position of the drive pin 404 of FIG. 7) occurs in response to an application of heat to the shape memory alloy 708. Conversely, a twisting and/or rotating of the drive shaft 402 via the shape memory alloy 708 from the second position (e.g., a position corresponding to the second position of the drive pin 404 of FIG. 7) to the first position (e.g., a position corresponding to the first position of the drive pin 404 of FIG. 7) occurs in response to removal of the application of heat from the shape memory alloy 708. The implementation of the shape memory alloy 708 as a mechanism for rotating the drive shaft 402 advantageously provides for an actuation system having a reduced footprint, a reduced weight, a reduced number of movable components, and/or a reduced cost relative to other actuation systems (e.g., hydraulic actuators, pneumatic actuators, etc.) that may be implemented to rotate the drive shaft 402.

In the illustrated example of FIG. 7, the drive shaft 402 has a length and a diameter. An increase in the length of the drive shaft 402 enables a greater degree of twisting and/or rotation of the drive shaft 402 via the shape memory alloy 708. Conversely, a decrease in the length of the drive shaft 402 enables a lesser degree of twisting and/or rotation of the drive shaft 402 via the shape memory alloy 708. An increase in the diameter of the drive shaft 402 enables a greater degree of torque to be delivered by the drive shaft 402 and/or the drive pin 404 via the shape memory alloy 708. Conversely, a decrease in the diameter of the drive shaft 402 enables a lesser degree of torque to be delivered by the drive shaft 402 and/or the drive pin 404 via the shape memory alloy 708. In some examples, the ratio of the length of the drive shaft 402 to the diameter of the drive shaft 402 will be between approximately 5:1 and approximately 8:1.

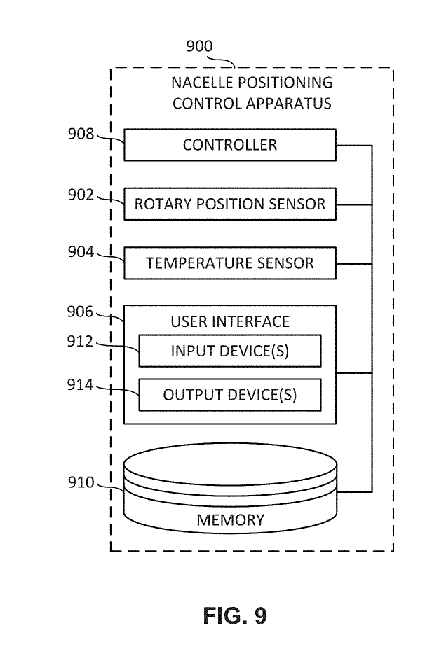

FIG. 8 is a perspective view of an example heat blanket 802 operatively coupled to the shape memory alloy 708 of the example drive shaft 402 of FIG. 7. In the illustrated example of FIG. 8, the heat blanket 802 is implemented as a wire coil wrapped around a portion of the length of the drive shaft 402. The heat blanket 802 generates heat in response to a controllable electrical current passing through the wire coil. In some examples, the electrical current passing through the wire coil of the heat blanket 802 is controllable via the example nacelle positioning control apparatus described below in connection with FIG. 9. The heat generated by the heat blanket 802 is applied to the shape memory alloy 708 of the drive shaft 402. In response to the application of heat via the heat blanket 802, the shape memory alloy 708 causes the first end 702 of the drive shaft to twist and/or rotate relative to the rigidly coupled second end 704 of the drive shaft 402 from a first position (e.g., a position corresponding to the first position of the drive pin 404 of FIG. 7) to a second position (e.g., a position corresponding to the second position of the drive pin 404 of FIG. 7).

FIG. 9 is a block diagram of an example nacelle positioning control apparatus 900 for controlling a position of an example drive member (e.g., the drive shaft 402 and/or the drive pin 404 of FIGS. 4-8), and/or for controlling an incident angle of an example nacelle (e.g., the nacelle 202 of FIGS. 2 and 3) positionable via the example variable incident nacelle apparatus 200 of FIGS. 2-8. As described in greater detail herein, the nacelle positioning control apparatus 900 of FIG. 9 is included as part of, and/or is operatively coupled to one or more structure(s) and/or component(s) of, the variable incident nacelle apparatus 200 of FIGS. 2-8. In the illustrated example of FIG. 9, the nacelle positioning control apparatus 900 includes an example rotary position sensor 902, an example temperature sensor 904, an example user interface 906, an example controller 908, and an example memory 910. However, other example implementations of the nacelle positioning control apparatus 900 may include fewer or additional structures in accordance with the teachings of this disclosure.

The example rotary position sensor 902 of FIG. 9 is operatively coupled to the drive member (e.g., the drive shaft 402 and/or the drive pin 404 of FIGS. 4-8) of the variable incident nacelle apparatus 200 of FIGS. 2-8. The rotary position sensor 902 of FIG. 9 senses, measures and/or detects a position (e.g., an angular position and/or angular displacement) of the drive member (e.g., the drive shaft 402 and/or the drive pin 404 of FIGS. 4-8). For example, the rotary position sensor 902 may sense, measure and/or detect that the drive shaft 402 and/or the drive pin 404 is in a position corresponding to the first position of FIG. 4, in a position corresponding to the second position of FIG. 5, or in one or more position(s) deviating from the first position of FIG. 4 and/or the second position of FIG. 5. In the illustrated example of FIG. 9, the position of the drive shaft 402 and/or the drive pin 404 sensed, measured and/or detected by the rotary position sensor 902 is provided to and/or made accessible to the controller 908 of FIG. 9. Position data sensed, measured and/or detected by the rotary position sensor 902 may be of any type, form and/or format, and may be stored in a computer-readable storage medium such as the example memory 910 described below.

The example temperature sensor 904 of FIG. 9 is operatively coupled to the drive member (e.g., the drive shaft 402 of FIGS. 4-8) of the variable incident nacelle apparatus 200 of FIGS. 2-8. The temperature sensor 904 of FIG. 9 senses, measures and/or detects a temperature of the drive member (e.g., the drive shaft 402 of FIGS. 4-8). For example, the temperature sensor 904 may sense, measure and/or detect that the drive shaft 402 is at a temperature that corresponds to a particular position of the drive shaft 402 and/or the drive pin 404 of FIGS. 4-8 (e.g., the first position of FIG. 4, the second position of FIG. 5, or in one or more position(s) deviating from the first position of FIG. 4 and/or the second position of FIG. 5). In the illustrated example of FIG. 9, the temperature of the drive shaft 402 sensed, measured and/or detected by the temperature sensor 904 is provided to and/or made accessible to the controller 908 of FIG. 9. Temperature data sensed, measured and/or detected by the temperature sensor 904 may be of any type, form and/or format, and may be stored in a computer-readable storage medium such as the example memory 910 described below.

The example user interface 906 of FIG. 9 facilitates interactions and/or communications between an end user and the nacelle positioning control apparatus 900 of FIG. 9. In some examples, the user interface 906 is located in a cockpit area (e.g., the cockpit area 114 of FIG. 1) of an aircraft including the nacelle positioning control apparatus 900 of FIG. 9. The user interface 906 includes one or more input device(s) 912 via which the user may input information and/or data to the controller 908 of the nacelle positioning control apparatus 900. For example, the input device(s) 912 may be implemented as one or more of a button, a switch, a dial, and/or a touchscreen that enable(s) the user to convey data and/or commands to the controller 908 of the nacelle positioning control apparatus 900. In some examples, the data and/or command(s) conveyed via the input device(s) 912 of the user interface 906 identify and/or indicate a desired position of a nacelle (e.g., a desired incident angle of the nacelle 202 of FIGS. 2 and 3). The user interface 906 of FIG. 9 also includes one or more output device(s) 914 via which the controller 908 of the nacelle positioning control apparatus 900 presents information and/or data in visual and/or audible form to the user. For example, the output device(s) 914 may be implemented as one or more of a light emitting diode, a touchscreen, and/or a liquid crystal display for presenting visual information, and/or a speaker for presenting audible information. In some examples, the data and/or information conveyed via the output device(s) 914 of the user interface 906 identify and/or indicate a current position of a nacelle (e.g., a current incident angle of the nacelle 202 of FIGS. 2 and 3). Data and/or information that is presented and/or received via the user interface 906 may be of any type, form and/or format, and may be stored in a computer-readable storage medium such as the example memory 910 described below.

The example controller 908 of FIG. 9 may be implemented by a semiconductor device such as a processor, microprocessor, or microcontroller. The controller 908 manages and/or controls the operation of the nacelle positioning control apparatus 900 of FIG. 9 based on data, information and/or one or more signal(s) obtained and/or accessed by the controller 908 from one or more of the rotary position sensor 902, the temperature sensor 904, the user interface 906 and/or the memory 910, and/or based on data, information and/or one or more signal(s) provided by the controller 908 to one or more of the user interface 906 and/or the memory 910.

In some examples, the controller 908 of FIG. 9 receives an input control signal corresponding to a desired position of a nacelle. For example, the controller 908 may receive an input control signal via the one or more input device(s) 912 of the user interface 906 of FIG. 9 identifying and/or indicating a desired position (e.g., a desired incident angle) of a nacelle corresponding to the second position of the nacelle 202 of FIG. 3.

In some examples, the controller 908 of FIG. 9 determines a current position of the nacelle. For example, the controller 908 may determine a current position (e.g., a current incident angle) of the nacelle corresponding to the first position of the nacelle 202 of FIG. 2 by accessing, obtaining, and/or otherwise identifying position data sensed, measured and/or detected by the example rotary position sensor 902 of FIG. 9 and/or stored in the example memory 910 of FIG. 9 described below. In some examples, the controller 908 may determine a current position of the nacelle based on position correlation data stored in the example memory 910 of FIG. 9. In some such examples, the position correlation data enables the controller 908 to associate (e.g., correlate) a current position of the nacelle (e.g., a current incident angle of the nacelle) with a current position of a drive member that positions the nacelle (e.g., a current angular displacement of the drive shaft 402 and/or the drive pin 404 of FIGS. 4-8). In some such examples, the controller 908 determines the current position of the drive member by accessing, obtaining and/or otherwise identifying the position data sensed, measured and/or detected by the rotary position sensor 902 of FIG. 9 and/or stored in the example memory 910 of FIG. 9.

In some examples, the controller 908 of FIG. 9 generates one or more control signal(s) to move the nacelle from the identified current position to the identified desired position. For example, the controller 908 may generate a control signal that causes the nacelle, and/or the drive member that positions the nacelle, to move from the current position (e.g., the first position of FIGS. 2 and 4) to the desired position (e.g., the second position of FIGS. 3 and 5). In some such examples, the controller 908 may generate a control signal corresponding to an electrical current to be supplied to the example heat blanket 802 of FIG. 8 operatively coupled to the example drive shaft 402 of FIGS. 4-8. In response to the electrical current supplied to the heat blanket 802, the drive shaft 402 twists and/or rotates. In some examples, the one or more control signal(s) generated by the controller 908 and supplied to the actuator of the drive member that positions the nacelle correspond to a difference between the current position of the nacelle and the desired position of the nacelle, and/or to a difference between the current position of the drive member and the desired position of the drive member. The one or more control signal(s) generated and/or supplied by the controller 908 cause the drive member to move in a direction corresponding to movement of the nacelle from the current position of the nacelle toward the desired position of the nacelle.

In some examples, following the generation of the one or more control signal(s) to move the nacelle, the controller 908 of FIG. 9 determines an updated current position of the nacelle. For example, the controller 908 may determine a current position of the nacelle that is updated (e.g., more recent) relative to the then-current position of the nacelle determined prior to the generation of the one or more control signal(s) to move the nacelle. The controller 908 may determine an updated current position of the nacelle by accessing, obtaining, and/or otherwise identifying the most recent position data sensed, measured and/or detected by the example rotary position sensor 902 of FIG. 9 and/or stored in the example memory 910 of FIG. 9. In some examples, the controller 908 may determine an updated current position of the nacelle based on position correlation data stored in the example memory 910 of FIG. 9. In some such examples, the position correlation data enables the controller 908 to associate (e.g., correlate) an updated current position of the nacelle (e.g., an updated current incident angle of the nacelle) with an updated current position of the drive member that positions the nacelle (e.g., an updated current angular displacement of the drive shaft 402 and/or the drive pin 404 of FIGS. 4-8). In some such examples, the controller 908 determines the updated current position of the drive member by accessing, obtaining and/or otherwise identifying the most recent position data sensed, measured and/or detected by the rotary position sensor 902 of FIG. 9 and/or stored in the example memory 910 of FIG. 9.

In some examples, the controller 908 of FIG. 9 determines a difference between the updated current position of the nacelle and the desired position of the nacelle. For example, the controller 908 may determine a difference between the updated current position of the nacelle and the desired position of the nacelle by comparing position data corresponding to the updated current position of the nacelle (e.g., the updated incident angle of the nacelle) to position data corresponding to the desired position of the nacelle (e.g., the desired incident angle of the nacelle).

In some examples, the controller 908 of FIG. 9 determines whether the difference between the updated current position of the nacelle and the desired position of the nacelle exceeds a position error threshold. For example, the controller 908 may determine that the difference between the updated current position of the nacelle and the desired position of the nacelle exceeds a position error threshold, thus indicating that the one or more control signal(s) generated by the controller 908 did not result in the nacelle being moved from its current position to the desired position within an acceptable margin of error. If the controller 908 determines that the difference between the updated current position of the nacelle and the desired position of the nacelle exceeds the position error threshold, the controller 908 may generate one or more additional control signal(s) to move the nacelle from the updated current position to the desired position.

In some examples, in response to the controller 908 of FIG. 9 receiving an input control signal corresponding to a desired position of a nacelle, the controller 908 determines a corresponding desired temperature of a drive member that positions the nacelle. For example, the controller 908 may determine a desired temperature of the drive member (e.g., the drive shaft 402 of FIGS. 4-8) based on temperature correlation data stored in the example memory 910 of FIG. 9. In some such examples, the temperature correlation data enables the controller 908 to associate (e.g., correlate) a position (e.g., a current position, a desired position, etc.) of the nacelle and/or the drive member with a corresponding temperature (e.g., a corresponding current temperature, a corresponding desired temperature, etc.) of the drive member.

In some examples, the controller 908 of FIG. 9 determines a current temperature of the drive member. For example, the controller 908 may determine a current temperature of the drive member (e.g., the drive shaft 402 of FIGS. 4-8) by accessing, obtaining, and/or otherwise identifying the temperature data sensed, measured and/or detected by the example temperature sensor 904 of FIG. 9 and/or stored in the example memory 910 of FIG. 9.

In some examples, the controller 908 of FIG. 9 generates one or more control signal(s) to change and/or adjust a temperature of the drive member from a current temperature to a desired temperature. For example, the controller 908 may generate a control signal that causes the temperature of the drive member (e.g., the drive shaft 402 of FIGS. 4-8) to increase and/or decrease from the current temperature (e.g., a temperature that results in the drive member being in first position of FIGS. 2 and 4) to the desired temperature (e.g., a temperature that results in the drive member being in the second position of FIGS. 3 and 5). In some such examples, the controller 908 may generate a control signal corresponding to an electrical current to be supplied to the example heat blanket 802 of FIG. 8 operatively coupled to the example drive shaft 402 of FIG. 8. In response to the electrical current supplied to the heat blanket 802, the temperature of the drive shaft 402 increases and/or decreases. In some examples, the one or more control signal(s) generated by the controller 908 and supplied to the actuator of the drive member that positions the nacelle correspond to a difference between the current temperature of the drive member and the desired temperature of the nacelle. The one or more control signal(s) generated and/or supplied by the controller 908 cause the temperature of the drive member to change in a direction corresponding to an increase and/or decrease of the temperature of the drive member from the current temperature toward the desired temperature.

In some examples, following the generation of the one or more control signal(s) to change and/or adjust the temperature of the drive member, the controller 908 of FIG. 9 determines an updated current temperature of the drive member. For example, the controller 908 may determine a current temperature of the drive member that is updated (e.g., more recent) relative to the then-current temperature of the drive member determined prior to the generation of the one or more control signal(s) to change the temperature of the drive member. The controller 908 may determine an updated current temperature of the drive member by accessing, obtaining, and/or otherwise identifying the most recent temperature data sensed, measured and/or detected by the example temperature sensor 904 of FIG. 9 and/or stored in the example memory 910 of FIG. 9.

In some examples, the controller 908 of FIG. 9 determines a difference between the updated current temperature of the drive member and the desired temperature of the drive member. For example, the controller 908 may determine a difference between the updated current temperature of the drive member and the desired temperature of the drive member by comparing temperature data corresponding to the updated current temperature of the drive member to temperature data corresponding to the desired temperature of the drive member.

In some examples, the controller 908 of FIG. 9 determines whether the difference between the updated current temperature of the drive member and the desired temperature of the drive member exceeds a temperature error threshold. For example, the controller 908 may determine that the difference between the updated current temperature of the drive member and the desired temperature of the drive member exceeds a temperature error threshold, thus indicating that the one or more control signal(s) generated by the controller 908 did not result in the temperature of the drive member changing from its current temperature to the desired temperature within an acceptable margin of error. If the controller 908 determines that the difference between the updated current temperature of the drive member and the desired temperature of the drive member exceeds the temperature error threshold, the controller 908 may generate one or more additional control signal(s) to change the temperature of the drive member from the updated current temperature to the desired temperature.

In some examples, the controller 908 of FIG. 9 instructs the example user interface 906 of FIG. 9 to present data and/or information corresponding to the current position of the nacelle. For example, the controller 908 may provide one or more command(s) and/or instruction(s) to the user interface 906 instructing the user interface 906 to present data and/or information corresponding to the current position of the nacelle (e.g., a current incident angle of the nacelle) following the generation of the one or more control signal(s) by the controller 908. In some examples, such command(s) and/or instruction(s) may be predetermined and/or otherwise defined by an application and/or program executing on the nacelle positioning control apparatus 900. In other examples, such command(s) and/or instruction(s) may be associated with one or more user input(s) received via the user interface 906 of FIG. 9. In response to such command(s) and/or instruction(s), the user interface 906 may present data and/or information corresponding to the current position of the nacelle via the one or more output device(s) 914 of the user interface 906.

In some examples, the controller 908 of FIG. 9 determines whether the nacelle positioning control apparatus 900 of FIG. 9 is to continue receiving input control signals corresponding to desired positions of the nacelle. For example, the controller 908 may receive one or more command(s) and or instruction(s) indicating that the nacelle positioning control apparatus 900 is not to continue receiving input control signals corresponding to desired positions of the nacelle. In some examples, such command(s) and/or instruction(s) may be predetermined and/or otherwise defined by an application and/or program executing on the nacelle positioning control apparatus 900. In other examples, such command(s) and/or instruction(s) may be associated with one or more user input(s) received via the user interface 906 of FIG. 9. If the controller 908 determines that the nacelle positioning control apparatus 900 is not to continue receiving input control signals corresponding to desired positions of the nacelle, the controller 908 may cease generating control signals to move the nacelle.

The example memory 910 of FIG. 9 may be implemented by any type(s) and/or any number(s) of storage device(s) such as a storage drive, a flash memory, a read-only memory (ROM), a random-access memory (RAM), a cache and/or any other storage medium in which information is stored for any duration (e.g., for extended time periods, permanently, brief instances, for temporarily buffering, and/or for caching of the information). The information stored in the memory 910 may be stored in any file and/or data structure format, organization scheme, and/or arrangement. In some examples, the memory 910 stores desired position data derived from one or more signals, messages and/or commands received via the user interface 906 of FIG. 9. In some examples, the memory 910 stores current position data sensed, measured and/or detected by the rotary position sensor 902 of FIG. 9. In some examples, the memory 910 stores position correlation data that may be accessed to associate (e.g. correlate) a position of the nacelle (e.g., a current position, a desired position, etc.) to a corresponding position (e.g., a corresponding current position, a corresponding desired position, etc.) of a drive member that positions the nacelle. In some examples, the memory 910 stores a position error threshold. In some examples, the memory 910 stores current position data to be presented via the user interface 906 of FIG. 9. In some examples, the memory 910 stores current temperature data sensed, measured and/or detected by the temperature sensor 904 of FIG. 9. In some examples, the memory 910 stores temperature correlation data that may be accessed to associate (e.g. correlate) a position (e.g., a current position, a desired position, etc.) of the nacelle and/or the drive member that positions the nacelle to a corresponding temperature (e.g., a corresponding current temperature, a corresponding desired temperature, etc.) of the drive member. In some examples, the memory 910 stores a temperature error threshold. The memory 910 is accessible to the example rotary position sensor 902, the example temperature sensor 904, the example user interface 906, and the example controller 908 of FIG. 9, and/or, more generally, to the example nacelle positioning control apparatus 900 of FIG. 9.

While an example manner of implementing the example nacelle positioning control apparatus 900 is illustrated in FIG. 9, one or more of the elements, processes and/or devices illustrated in FIG. 9 may be combined, divided, re-arranged, omitted, eliminated and/or implemented in any other way. Further, the example rotary position sensor 902, the example temperature sensor 904, the example user interface 906, the example controller 908 and/or the example memory 910 of FIG. 9 may be implemented by hardware, software, firmware and/or any combination of hardware, software and/or firmware. Thus, for example, any of the example rotary position sensor 902, the example temperature sensor 904, the example user interface 906, the example controller 908 and/or the example memory 910 of FIG. 9 could be implemented by one or more analog or digital circuit(s), logic circuits, programmable processor(s), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example rotary position sensor 902, the example temperature sensor 904, the example user interface 906, the example controller 908 and/or the example memory 910 of FIG. 9 is/are hereby expressly defined to include a tangible computer readable storage device or storage disk such as a memory, a digital versatile disk (DVD), a compact disk (CD), a Blu-ray disk, etc. storing the software and/or firmware. Further still, the example nacelle positioning control apparatus 900 of FIG. 9 may include one or more elements, processes and/or devices in addition to, or instead of, those illustrated in FIG. 9, and/or may include more than one of any or all of the illustrated elements, processes and devices.

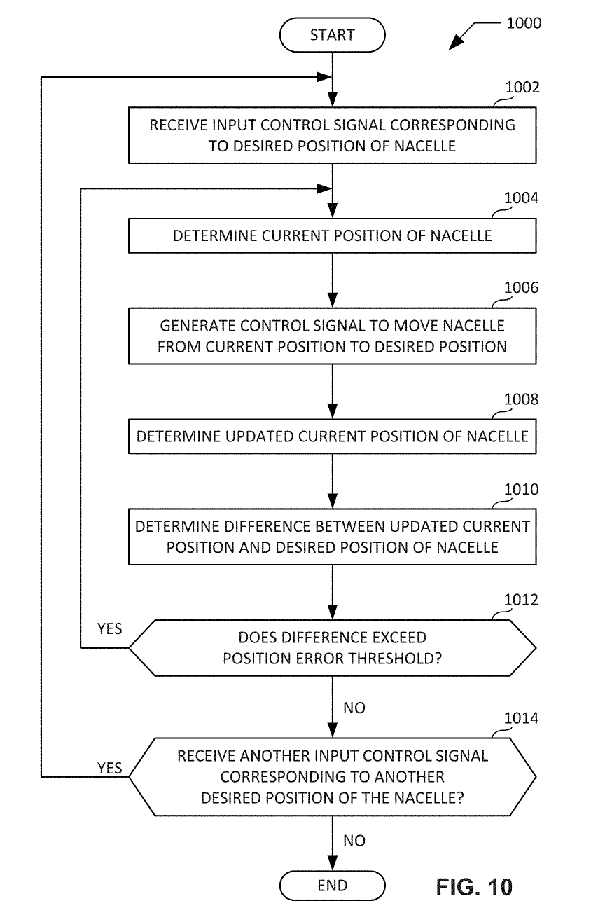

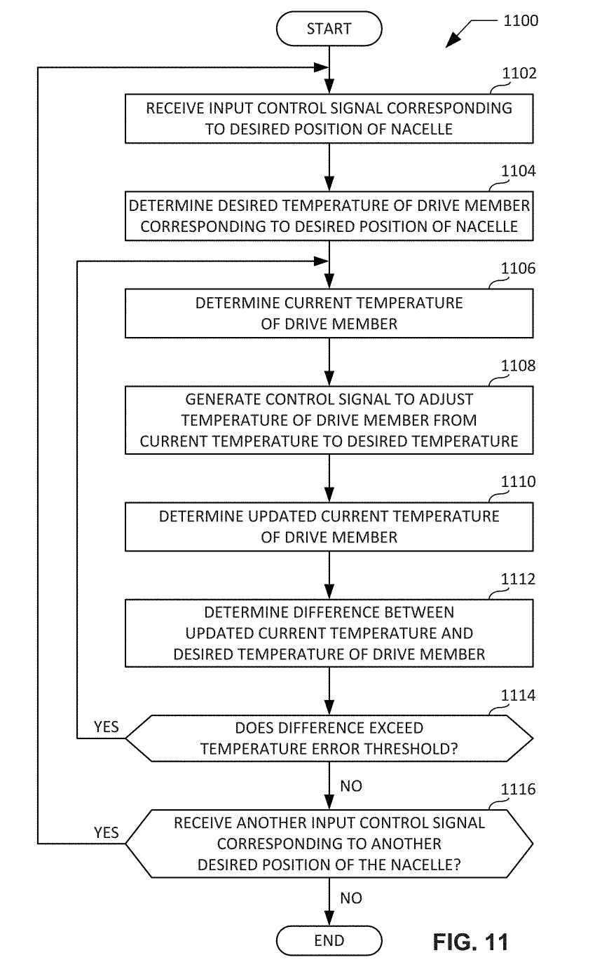

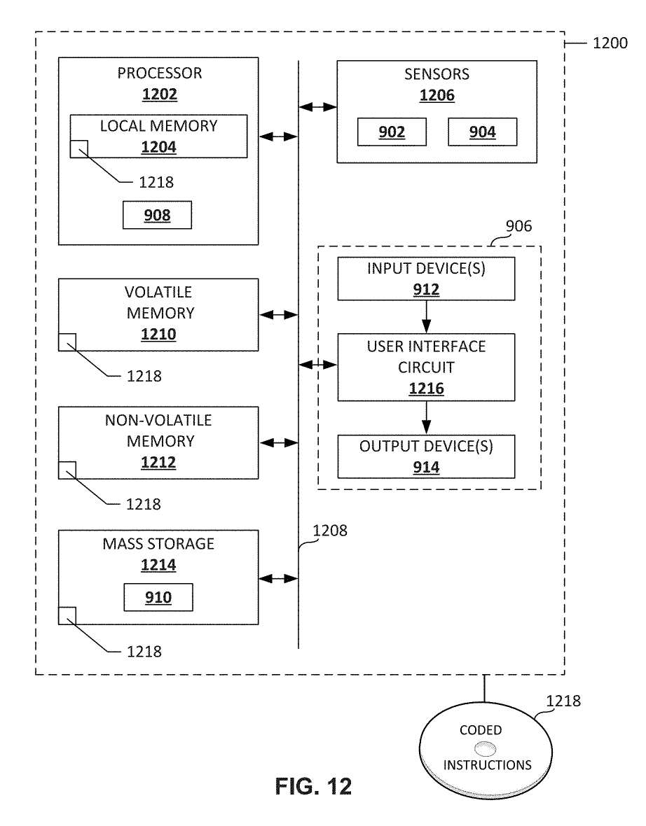

Flowcharts representative of example methods for controlling an incident angle of a nacelle positionable via the example variable incident nacelle apparatus of FIGS. 2-8 and the example nacelle positioning control apparatus 900 of FIG. 9 are shown in FIGS. 10 and 11. In these examples, the methods may be implemented using machine-readable instructions that comprise one or more program(s) for execution by a processor such as the example processor 1202 shown in the example processor platform 1200 discussed below in connection with FIG. 12. The one or more program(s) may be embodied in software stored on a tangible computer readable storage medium such as a CD-ROM, a floppy disk, a hard drive, a digital versatile disk (DVD), a Blu-ray disk, or a memory associated with the processor 1202, but the entire program(s) and/or parts thereof could alternatively be executed by a device other than the processor 1202, and/or embodied in firmware or dedicated hardware. Further, although the example program(s) is/are described with reference to the flowcharts illustrated in FIGS. 10 and 11, many other methods for controlling an incident angle of a nacelle may alternatively be used. For example, the order of execution of the blocks may be changed, and/or some of the blocks described may be changed, eliminated, or combined.

As mentioned above, the example methods of FIGS. 10 and 11 may be implemented using coded instructions (e.g., computer and/or machine-readable instructions) stored on a tangible computer readable storage medium such as a hard disk drive, a flash memory, a read-only memory (ROM), a compact disk (CD), a digital versatile disk (DVD), a cache, a random-access memory (RAM) and/or any other storage device or storage disk in which information is stored for any duration (e.g., for extended time periods, permanently, for brief instances, for temporarily buffering, and/or for caching of the information). As used herein, the term “tangible computer readable storage medium” is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example methods of FIGS. 10 and 11 may be implemented using coded instructions (e.g., computer and/or machine-readable instructions) stored on a non-transitory computer and/or machine-readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term “non-transitory computer readable medium” is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 10 is a flowchart representative of a first example method 1000 that may be executed at the example nacelle positioning control apparatus 900 of FIG. 9 to control an incident angle of a nacelle positionable via the example variable incident nacelle apparatus 200 of FIGS. 2-8. The example method 1000 begins when the example controller 908 of FIG. 9 receives an input control signal corresponding to a desired position of a nacelle (block 1002). For example, the controller 908 may receive an input control signal via one or more of the input device(s) 912 of the user interface 906 of FIG. 9 identifying and/or indicating a desired position of a nacelle (e.g., the second position of the nacelle 202 of FIG. 3). Following block 1002, control of the example method 1000 of FIG. 10 proceeds to block 1004.

At block 1004, the example controller 908 of FIG. 9 determines a current position of the nacelle (block 1004). For example, the controller 908 may determine a current position of the nacelle (e.g., the first position of the nacelle 202 of FIG. 2) by accessing, obtaining, and/or otherwise identifying the position data sensed, measured and/or detected by the example rotary position sensor 902 of FIG. 9 and/or stored in the example memory 910 of FIG. 9. In some examples, the controller 908 may determine a current position of the nacelle based on position correlation data stored in the example memory 910 of FIG. 9. In some such examples, the position correlation data enables the controller 908 to associate (e.g., correlate) a current position of the nacelle (e.g., a current incident angle of the nacelle) with a current position of a drive member that positions the nacelle (e.g., a current angular displacement of the drive shaft 402 and/or the drive pin 404 of FIGS. 4-8). In some such examples, the controller 908 determines the current position of the drive member by accessing, obtaining and/or otherwise identifying the position data sensed, measured and/or detected by the rotary position sensor 902 of FIG. 9 and/or stored in the example memory 910 of FIG. 9. Following block 1004, control of the example method 1000 of FIG. 10 proceeds to block 1006.

At block 1006, the example controller 908 of FIG. 9 generates one or more control signal(s) to move a nacelle from a current position to a desired position (block 1006). For example, the controller 908 may generate a control signal that causes the nacelle, and/or a drive member that positions the nacelle, to move from the current position (e.g., the first position of FIGS. 2 and 4) to the desired position (e.g., the second position of FIGS. 3 and 5). In some such examples, the controller 908 may generate a control signal corresponding to an electrical current to be supplied to the example heat blanket 802 of FIG. 8 operatively coupled to the example drive shaft 402 of FIG. 8. In response to the electrical current supplied to the heat blanket 802, the drive shaft 402 twists and/or rotates. In some examples, the one or more control signal(s) generated by the controller 908 and supplied to the actuator of the drive member that positions the nacelle correspond to a difference between the current position of the nacelle and the desired position of the nacelle, and/or to a difference between the current position of the drive member and the desired position of the drive member. The one or more control signal(s) generated and/or supplied by the controller 908 cause the drive member to move in a direction corresponding to movement of the nacelle from the current position of the nacelle toward the desired position of the nacelle. Following block 1006, control of the example method 1000 of FIG. 10 proceeds to block 1008.

At block 1008, the example controller 908 of FIG. 9 determines an updated current position of the nacelle (block 1004). For example, the controller 908 may determine a current position of the nacelle that is updated (e.g., more recent) relative to the current position of the nacelle determined at block 1004 of the example method 1000, as described above. The controller 908 may determine an updated current position of the nacelle by accessing, obtaining, and/or otherwise identifying the most recent position data sensed, measured and/or detected by the example rotary position sensor 902 of FIG. 9 and/or stored in the example memory 910 of FIG. 9. In some examples, the controller 908 may determine an updated current position of the nacelle based on position correlation data stored in the example memory 910 of FIG. 9. In some such examples, the position correlation data enables the controller 908 to associate (e.g., correlate) an updated current position of the nacelle (e.g., an updated current incident angle of the nacelle) with an updated current position of the drive member that positions the nacelle (e.g., an updated current angular displacement of the drive shaft 402 and/or the drive pin 404 of FIGS. 4-8). In some such examples, the controller 908 determines the updated current position of the drive member by accessing, obtaining and/or otherwise identifying the most recent position data sensed, measured and/or detected by the rotary position sensor 902 of FIG. 9 and/or stored in the example memory 910 of FIG. 9. Following block 1008, control of the example method 1000 of FIG. 10 proceeds to block 1010.

At block 1010, the example controller 908 of FIG. 9 determines a difference between the updated current position of the nacelle and the desired position of the nacelle (block 1010). For example, the controller 908 may determine a difference between the updated current position of the nacelle and the desired position of the nacelle by comparing position data corresponding to the updated current position of the nacelle (e.g., the updated incident angle of the nacelle) to position data corresponding to the desired position of the nacelle (e.g., the desired incident angle of the nacelle). Following block 1010, control of the example method 1000 of FIG. 10 proceeds to block 1012.

At block 1012, the example controller 908 of FIG. 9 determines whether the difference between the updated current position of the nacelle and the desired position of the nacelle exceeds a position error threshold (block 1012). For example, the controller 908 may determine that the difference between the updated current position of the nacelle and the desired position of the nacelle exceeds a position error threshold, thus indicating that the one or more control signal(s) generated by the controller 908 at block 1006 of the example method 1000 of FIG. 10 did not result in the nacelle being moved from its current position to the desired position within an acceptable margin of error. If the controller 908 determines at block 1012 that the difference between the updated current position of the nacelle and the desired position of the nacelle exceeds the position error threshold, control of the example method 1000 of FIG. 10 returns to block 1004. If the controller 908 instead determines at block 1012 that the difference between the updated current position of the nacelle and the desired position of the nacelle does not exceed the position error threshold, control of the example method 1000 of FIG. 10 proceeds to block 1014.

At block 1014, the example controller 908 of FIG. 9 determines whether the nacelle positioning control apparatus 900 of FIG. 9 is to receive another input control signal corresponding to another desired position of the nacelle (block 1014). For example, the controller 908 may receive one or more command(s) and or instruction(s) indicating that the nacelle positioning control apparatus 900 is not to receive another input control signal corresponding to another desired position of the nacelle. In some examples, such command(s) and/or instruction(s) may be predetermined and/or otherwise defined by an application and/or program executing on the nacelle positioning control apparatus 900. In other examples, such command(s) and/or instruction(s) may be associated with one or more user input(s) received via the input device(s) 912 of the user interface 906 of FIG. 9. If the controller 908 determines at block 1014 that the nacelle positioning control apparatus 900 is to receive another input control signal corresponding to another desired position of the nacelle, control of the example method 1000 of FIG. 10 returns to block 1002. If the controller 908 instead determines at block 1014 that the nacelle positioning control apparatus 900 is not to receive another input control signal corresponding to another desired position of the nacelle, control of the example method 1000 of FIG. 10 ends.

FIG. 11 is a flowchart representative of a second example method 1100 that may be executed at the example nacelle positioning control apparatus 900 of FIG. 9 to control an incident angle of a nacelle positionable via the example variable incident nacelle apparatus 200 of FIGS. 2-8. The example method 1100 begins when the example controller 908 of FIG. 9 receives an input control signal corresponding to a desired position of a nacelle (block 1102). For example, the controller 908 may receive an input control signal via one or more of the input device(s) 912 of the user interface 906 of FIG. 9 identifying and/or indicating a desired position of a nacelle (e.g., the second position of the nacelle 202 of FIG. 3). Following block 1102, control of the example method 1100 of FIG. 11 proceeds to block 1104.

At block 1104, the example controller 908 of FIG. 9 determines a desired temperature of a drive member that positions the nacelle corresponding to the desired position of the nacelle (block 1104). For example, the controller 908 may determine a desired temperature of the drive member (e.g., the drive shaft 402 of FIGS. 4-8) based on temperature correlation data stored in the example memory 910 of FIG. 9. In some such examples, the temperature correlation data enables the controller 908 to associate (e.g., correlate) a position (e.g., a current position, a desired position, etc.) of the nacelle and/or the drive member with a corresponding temperature (e.g., a corresponding current temperature, a corresponding desired temperature, etc.) of the drive member. Following block 1104, control of the example method 1100 of FIG. 11 proceeds to block 1106.

At block 1106, the example controller 908 of FIG. 9 determines a current temperature of the drive member (block 1106). For example, the controller 908 may determine a current temperature of the drive member (e.g., the drive shaft 402 of FIGS. 4-8) by accessing, obtaining, and/or otherwise identifying the temperature data sensed, measured and/or detected by the example temperature sensor 904 of FIG. 9 and/or stored in the example memory 910 of FIG. 9. Following block 1106, control of the example method 1100 of FIG. 11 proceeds to block 1108.

At block 1108, the example controller 908 of FIG. 9 generates one or more control signal(s) to change and/or adjust a temperature of the drive member from a current temperature to a desired temperature (block 1108). For example, the controller 908 may generate a control signal that causes the temperature of the drive member (e.g., the drive shaft 402 of FIGS. 4-8) to increase and/or decrease from the current temperature (e.g., a temperature that results in the drive member being in first position of FIGS. 2 and 4) to the desired temperature (e.g., a temperature that results in the drive member being in the second position of FIGS. 3 and 5). In some such examples, the controller 908 may generate a control signal corresponding to an electrical current to be supplied to the example heat blanket 802 of FIG. 8 operatively coupled to the example drive shaft 402 of FIG. 8. In response to the electrical current supplied to the heat blanket 802, the temperature of the drive shaft 402 increases and/or decreases. In some examples, the one or more control signal(s) generated by the controller 908 and supplied to the actuator of the drive member that positions the nacelle correspond to a difference between the current temperature of the drive member and the desired temperature of the nacelle. The one or more control signal(s) generated and/or supplied by the controller 908 cause the temperature of the drive member to change in a direction corresponding to an increase and/or decrease of the temperature of the drive member from the current temperature toward the desired temperature. Following block 1108, control of the example method 1100 of FIG. 11 proceeds to block 1110.

At block 1110, the example controller 908 of FIG. 9 determines an updated current temperature of the drive member (block 1110). For example, the controller 908 may determine a current temperature of the drive member that is updated (e.g., more recent) relative to the current temperature of the nacelle determined at block 1106 of the example method 1100, as described above. The controller 908 may determine an updated current temperature of the drive member by accessing, obtaining, and/or otherwise identifying the most recent temperature data sensed, measured and/or detected by the example temperature sensor 904 of FIG. 9 and/or stored in the example memory 910 of FIG. 9. Following block 1110, control of the example method 1100 of FIG. 11 proceeds to block 1112.

At block 1112, the example controller 908 of FIG. 9 determines a difference between the updated current temperature of the drive member and the desired temperature of the drive member (block 1112). For example, the controller 908 may determine a difference between the updated current temperature of the drive member and the desired temperature of the drive member by comparing temperature data corresponding to the updated current temperature of the drive member to temperature data corresponding to the desired temperature of the drive member. Following block 1112, control of the example method 1100 of FIG. 1 proceeds to block 1114.

At block 1114, the example controller 908 of FIG. 9 determines whether the difference between the updated current temperature of the drive member and the desired temperature of the drive member exceeds a temperature error threshold (block 1114). For example, the controller 908 may determine that the difference between the updated current temperature of the drive member and the desired temperature of the drive member exceeds a temperature error threshold, thus indicating that the one or more control signal(s) generated by the controller 908 at block 1108 of the example method 1100 of FIG. 11 did not result in the temperature of the drive member changing from its current temperature to the desired temperature within an acceptable margin of error. If the controller 908 determines at block 1114 that the difference between the updated current temperature of the drive member and the desired temperature of the drive member exceeds the temperature error threshold, control of the example method 1100 of FIG. 11 returns to block 1106. If the controller 908 instead determines at block 1114 that the difference between the updated current temperature of the drive member and the desired temperature of the drive member does not exceed the temperature error threshold, control of the example method 1100 of FIG. 11 proceeds to block 1116.

At block 1116, the example controller 908 of FIG. 9 determines whether the nacelle positioning control apparatus 900 of FIG. 9 is to receive another input control signal corresponding to another desired position of the nacelle (block 1116). For example, the controller 908 may receive one or more command(s) and or instruction(s) indicating that the nacelle positioning control apparatus 900 is not to receive another input control signal corresponding to another desired position of the nacelle. In some examples, such command(s) and/or instruction(s) may be predetermined and/or otherwise defined by an application and/or program executing on the nacelle positioning control apparatus 900. In other examples, such command(s) and/or instruction(s) may be associated with one or more user input(s) received via the input device(s) 912 of the user interface 906 of FIG. 9. If the controller 908 determines at block 1116 that the nacelle positioning control apparatus 900 is to receive another input control signal corresponding to another desired position of the nacelle, control of the example method 1100 of FIG. 11 returns to block 1102. If the controller 908 instead determines at block 1116 that the nacelle positioning control apparatus 900 is not to receive another input control signal corresponding to another desired position of the nacelle, control of the example method 1100 of FIG. 11 ends.

FIG. 12 is an example processor platform 1200 capable of executing instructions to implement the methods of FIGS. 10 and 11 and the example nacelle positioning control apparatus 900 of FIG. 9. The processor platform 1200 of the illustrated example includes a processor 1202. The processor 1202 of the illustrated example is hardware. For example, the processor 1202 can be implemented by one or more integrated circuit(s), logic circuit(s), microprocessor(s) or controller(s) from any desired family or manufacturer. The processor 1202 of the illustrated example includes a local memory 1204 (e.g., a cache) and the example controller 908 of FIG. 9.

The processor 1202 of the illustrated example is in communication with one or more example sensors 1206 via a bus 1208. The example sensors 1206 include the example rotary position sensor 902 and the example temperature sensor 904 of FIG. 9.

The processor 1202 of the illustrated example is also in communication with a main memory including a volatile memory 1210 and a non-volatile memory 1212 via the bus 1208. The volatile memory 1210 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1212 may be implemented by flash memory and/or any other desired type of memory device. Access to the volatile memory 1210 and the non-volatile memory 1212 is controlled by a memory controller.

The processor 1202 of the illustrated example is also in communication with one or more mass storage devices 1214 for storing software and/or data. Examples of such mass storage devices 1214 include floppy disk drives, hard drive disks, compact disk drives, Blu-ray disk drives, RAID systems, and digital versatile disk (DVD) drives. In the illustrated example, the mass storage device 1214 includes the example memory 910 of FIG. 9.

The processor platform 1200 of the illustrated example also includes a user interface circuit 1216. The user interface circuit 1216 may be implemented by any type of interface standard, such as an Ethernet interface, a universal serial bus (USB), and/or a PCI express interface. In the illustrated example, one or more input device(s) 912 are connected to the user interface circuit 1216. The input device(s) 912 permit(s) a user to enter data and commands into the processor 1202. The input device(s) 912 can be implemented by, for example, a button, a switch, a dial, an audio sensor, a camera (still or video), a keyboard, a mouse, a touchscreen, a track-pad, a trackball, isopoint, a voice recognition system, a microphone, and/or a liquid crystal display. One or more output device(s) 914 are also connected to the user interface circuit 1216 of the illustrated example. The output device(s) 914 can be implemented, for example, by a light emitting diode, an organic light emitting diode, a liquid crystal display, a touchscreen and/or a speaker. The user interface circuit 1216 of the illustrated example may, thus, include a graphics driver such as a graphics driver chip and/or processor. In the illustrated example, the input device(s) 912, the output device(s) 914 and the user interface circuit 1216 collectively form the example user interface 906 of FIG. 9.

Coded instructions 1218 for implementing the method 1000 of FIG. 10 and/or the method 1100 of FIG. 11 may be stored in the local memory 1204, in the volatile memory 1210, in the non-volatile memory 1212, in the mass storage device 1214, and/or on a removable tangible computer readable storage medium such as a CD or DVD.

From the foregoing, it will be appreciated that the disclosed variable incident nacelle apparatus and methods provide numerous advantages over conventional nacelle attachment apparatus. For example, implementation of the disclosed variable incident nacelle apparatus and methods in an aircraft (e.g., a derivative commercial aircraft) advantageously enables a nacelle and/or an engine of increased diameter to be fitted to the aircraft without the need for increasing the length of the landing gear of the aircraft. As a result, increases to the weight of the aircraft and/or reductions to the available fuel storage space of the aircraft associated with increasing the length of the landing gear are reduced and/or avoided. Thus, implementation of the disclosed variable incident nacelle apparatus is advantageous with respect to the operating costs associated with commercial aircraft.

Implementation of the disclosed variable incident nacelle apparatus and methods in an aircraft also advantageously improves a specific fuel consumption of the aircraft and/or provides a drag benefit associated with a cruising operation of the aircraft by aligning and/or positioning the nacelle at an incident angle corresponding to a velocity vector associated with the aircraft during the cruising operation. Implementation of the disclosed variable incident nacelle apparatus and methods in an aircraft also advantageously reduces a load and/or force applied to an extended wing flap of the aircraft (e.g., loads and/or forces resulting from an exhaust plume generated by the engine of the aircraft) by aligning and/or positioning the nacelle and/or the engine at an incident angle that causes the exhaust plume of the engine to be directed away from the extended wing flap. In addition to reducing the load and/or forces applied to the extended wing flap, aligning and/or positioning the nacelle and/or the engine at an incident angle that causes the exhaust plume of the engine to be directed away from the extended wing flap also advantageously reduces noise that otherwise results from the engine plume impacting the extended wing flap.

The aforementioned advantages and/or benefits are achieved via the disclosed variable incident nacelle apparatus and methods. In some examples, an apparatus for varying an incident angle of a nacelle of an aircraft engine relative to an aircraft wing is disclosed. In some disclosed examples, the apparatus comprises a pylon frame member to be rigidly coupled to the aircraft engine. In some disclosed examples, the pylon frame member is to be pivotable about a first axis of rotation. In some disclosed examples, the apparatus further comprises a diagonal brace including a first end defining an aperture to receive a portion of a drive member. In some disclosed examples, the portion of the drive member is to be rotatable relative to the aperture about a second axis of rotation. In some disclosed examples, the drive member includes a pin positioned eccentrically relative to the second axis of rotation. In some disclosed examples, the pin is to be coupled to the pylon frame member to pivot the pylon frame member in response to rotation of the portion of the drive member.

In some disclosed examples of the apparatus, the pylon frame member is pivotable between a first position and a second position. In some disclosed examples, a distance between a lowest extent of the nacelle of the aircraft engine and a chord of the aircraft wing is to be reduced in response to the pylon frame member pivoting from the first position to the second position.

In some disclosed examples of the apparatus, the first axis of rotation is parallel to the second axis of rotation. In some disclosed examples of the apparatus, the second axis of rotation is transverse to a longitudinal axis of the aircraft engine.

In some disclosed examples of the apparatus, the apparatus further includes a controller operatively coupled to the drive member to control a position of the drive member.

In some disclosed examples of the apparatus, the drive member includes a shape memory alloy. In some disclosed examples, the portion of the drive member is to rotate about the second axis of rotation in a first direction in response to heat being applied to the shape memory alloy, and to rotate about the second axis of rotation in a second direction opposite the first direction in response to the applied heat being removed from the shape memory alloy. In some disclosed examples, the apparatus further comprises a heat blanket to heat the shape memory alloy. In some disclosed examples, the apparatus further comprises a controller operatively coupled to the heat blanket and to the drive member to control a temperature of the drive member

In some examples, a method for varying an incident angle of a nacelle of an aircraft engine movably coupled to an aircraft wing is disclosed. In some disclosed examples, the method comprises rotating a portion of a drive member about a first axis of rotation. In some disclosed examples, the portion of the drive member is received in an aperture defined by a first end of a diagonal brace. In some disclosed examples, the drive member includes a pin positioned eccentrically relative to the first axis of rotation. In some disclosed examples, the pin is coupled to a pylon frame member to pivot the pylon frame member in response to the rotation of the portion of the drive member. In some disclosed examples, the pylon frame member is rigidly coupled to the aircraft engine and pivotable about a second axis of rotation.

In some disclosed examples, the method further comprises pivoting the pylon frame member between a first position and a second position to reduce a distance between a lowest extent of the nacelle of the aircraft engine and a chord of the aircraft wing.

In some disclosed examples, the method further comprises regulating a position of the drive member via a controller operatively coupled to the drive member.

In some disclosed examples of the method, the drive member includes a shape memory alloy. In some disclosed examples, the method further comprises rotating the portion of the drive member about the first axis of rotation in a first direction by applying heat to the shape memory alloy, and rotating the portion of the drive member about the first axis of rotation in a second direction opposite the first direction by removing the applied heat from the shape memory alloy. In some disclosed examples, the method further comprises applying heat to the shape memory alloy via a heat blanket. In some disclosed examples, the method further comprises regulating a temperature of the drive member via a controller operatively coupled to the heat blanket and to the drive member.

In some examples, a tangible machine readable storage medium comprising instructions is disclosed. In some disclosed examples, the instructions, when executed, cause a controller to determine a desired position of a nacelle of an aircraft engine movably coupled to an aircraft wing. In some disclosed examples, the instructions, when executed, further cause the controller to generate a control signal to move the nacelle to the desired position. In some disclosed examples, the control signal is to rotate a portion of a drive member about a first axis of rotation. In some disclosed examples, the portion of the drive member is received in an aperture defined by a first end of a diagonal brace. In some disclosed examples, the drive member includes a pin positioned eccentrically relative to the first axis of rotation. In some disclosed examples, the pin is coupled to a pylon frame member to pivot the pylon frame member in response to the rotation of the portion of the drive member. In some disclosed examples, the pylon frame member is rigidly coupled to the aircraft engine and pivotable about a second axis of rotation.

In some disclosed examples of tangible machine readable storage medium, the instructions, when executed, are further to cause the controller to determine a current position of the nacelle. In some disclosed examples, the control signal is based on a difference between the current position of the nacelle and the desired position of the nacelle.

In some disclosed examples of tangible machine readable storage medium, the instructions, when executed, are further to cause the controller to determine a desired temperature of the drive member corresponding to the desired position of the nacelle. In some disclosed examples, the drive member includes a shape memory alloy. In some disclosed examples of tangible machine readable storage medium, the instructions, when executed, are further to cause the controller to determine a current temperature of the drive member. In some disclosed examples, the control signal is based on a difference between the current temperature of the drive member and the desired temperature of the drive member. In some disclosed examples, the control signal is to cause heat to be applied to the shape memory alloy to rotate the portion of the drive member in a first direction about the first axis of rotation.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for varying an incident angle of a nacelle of an aircraft engine relative to an aircraft wing, the apparatus comprising:
a pylon frame member to be rigidly coupled to the aircraft engine, the pylon frame member to be pivotable about a first axis of rotation; and
a diagonal brace including a first end defining an aperture to receive a portion of a drive member, the portion of the drive member to be rotatable relative to the aperture about a second axis of rotation, the drive member including a pin positioned eccentrically relative to the second axis of rotation, the pin to be coupled to the pylon frame member to pivot the pylon frame member in response to rotation of the portion of the drive member.

2. The apparatus of claim 1, wherein the pylon frame member is pivotable between a first position and a second position, and wherein a distance between a lowest extent of the nacelle of the aircraft engine and a chord of the aircraft wing is to be reduced in response to the pylon frame member pivoting from the first position to the second position.

3. The apparatus of claim 1, wherein the first axis of rotation is parallel to the second axis of rotation.

4. The apparatus of claim 1, wherein the second axis of rotation is transverse to a longitudinal axis of the aircraft engine.

5. The apparatus of claim 1, further including a controller operatively coupled to the drive member to control a position of the drive member.

6. The apparatus of claim 1, wherein the drive member includes a shape memory alloy.

7. The apparatus of claim 6, wherein the portion of the drive member is to rotate about the second axis of rotation in a first direction in response to heat being applied to the shape memory alloy, and to rotate about the second axis of rotation in a second direction opposite the first direction in response to the applied heat being removed from the shape memory alloy.

8. The apparatus of claim 7, further comprising a heat blanket to heat the shape memory alloy.

9. The apparatus of claim 8, further including a controller operatively coupled to the heat blanket and to the drive member to control a temperature of the drive member.

10. A method for varying an incident angle of a nacelle of an aircraft engine movably coupled to an aircraft wing, the method comprising:
rotating a portion of a drive member about a first axis of rotation, the portion of the drive member being received in an aperture defined by a first end of a diagonal brace, the drive member including a pin positioned eccentrically relative to the first axis of rotation, the pin being coupled to a pylon frame member to pivot the pylon frame member in response to the rotation of the portion of the drive member, the pylon frame member being rigidly coupled to the aircraft engine and pivotable about a second axis of rotation.

11. The method of claim 10, further comprising pivoting the pylon frame member between a first position and a second position to reduce a distance between a lowest extent of the nacelle of the aircraft engine and a chord of the aircraft wing.

12. The method of claim 10, further comprising regulating a position of the drive member via a controller operatively coupled to the drive member.

13. The method of claim 10, wherein the drive member includes a shape memory alloy.

14. The method of claim 13, further comprising:
rotating the portion of the drive member about the first axis of rotation in a first direction by applying heat to the shape memory alloy; and
rotating the portion of the drive member about the first axis of rotation in a second direction opposite the first direction by removing the applied heat from the shape memory alloy.

15. The method of claim 14, further comprising applying heat to the shape memory alloy via a heat blanket.

16. The method of claim 15, further comprising regulating a temperature of the drive member via a controller operatively coupled to the heat blanket and to the drive member.

17. A tangible machine readable storage medium comprising instructions that, when executed, cause a controller to at least:
determine a desired position of a nacelle of an aircraft engine movably coupled to an aircraft wing; and
generate a control signal to move the nacelle to the desired position, the control signal to rotate a portion of a drive member about a first axis of rotation, the portion of the drive member being received in an aperture defined by a first end of a diagonal brace, the drive member including a pin positioned eccentrically relative to the first axis of rotation, the pin being coupled to a pylon frame member to pivot the pylon frame member in response to the rotation of the portion of the drive member, the pylon frame member being rigidly coupled to the aircraft engine and pivotable about a second axis of rotation.

18. The tangible machine readable storage medium of claim 17, wherein the instructions, when executed, are further to cause the controller to determine a current position of the nacelle, the control signal being based on a difference between the current position of the nacelle and the desired position of the nacelle.

19. The tangible machine readable storage medium of claim 17, wherein the instructions, when executed, are further to cause the controller to:
determine a desired temperature of the drive member corresponding to the desired position of the nacelle, the drive member including a shape memory alloy; and
determine a current temperature of the drive member, the control signal being based on a difference between the current temperature of the drive member and the desired temperature of the drive member.

20. The tangible machine readable storage medium of claim 19, wherein the control signal is to cause heat to be applied to the shape memory alloy to rotate the portion of the drive member in a first direction about the first axis of rotation.
